(19) United States
(12) Patent Application Publication
(10) Pub. No.: US 2023/0150847 A1
(43) Pub. Date: May 18, 2023

(54) PRESSURE BALANCING SYSTEM FOR TWO SIDES OF AN EDR FILM STACK

(71) Applicants: CHING-HSIUNG LIN, Pingtung City (TW); KEMFLO (Nanjing) Environment Technology Co., Ltd., Nanjing (CN); KEMFLO INTERNATIONAL CO., LTD., Nanjing (CN)

(72) Inventors: ALLEN DING, NANJING (CN); Xiao-Lyu HAN, NANJING (CN); EDISON FAN, NANJING (CN)

(21) Appl. No.: 17/540,580

(22) Filed: Dec. 2, 2021

(30) Foreign Application Priority Data
Nov. 17, 2021 (CN) 202111363292.1

(51) Int. Cl. C02F 1/469

(52) U.S. Cl. CPC C02F 1/4693; C02F 2209/03; C02F 2209/003; C02F 2201/005

(57) ABSTRACT

A pressure balancing system for two sides of an electrodialysis reversal (EDR) film stack includes two source water inlets, an EDR film stack, four pressure sensors, a variable speed pump, a one-way valve, a clean water outlet, a waste water outlet, and a control system module. With the four pressure sensors detecting water pressures at four ports on two sides of the EDR film stack and with the variable speed pump and the control system module adjusting water pressure at the waste water outlet, water pressure at the clean water outlet is equivalent to the water pressure at the waste water outlet. Accordingly, the water pressures on the two sides of the EDR film stack can be balanced, and service life and water purification efficiency of the EDR film stack can be improved.

### BACKGROUND OF THE INVENTION

### 1. Field of the Invention

The present invention relates to a pressure balancing system of filtration films of a water purifier, especially to a pressure balancing system for two sides of an electrodialysis reversal (EDR) film stack.

### 2. Description of the Prior Art(s)

With improvement of people's quality of life, many families have water purifiers installed in their houses, so as to ensure the safety of drinking water. However, after the water purifier has been used for a long time, a film stack in the water purifier is easily damaged due to difference in pressure on two sides of the film stack, thereby affecting service life of the film stack. Consequently, the film stack has to be replaced frequently, which leads to a decrease in water purification efficiency of the water purifier.

There is no good solution to the aforementioned problem in conventional water purifiers.

To overcome the shortcomings, the present invention provides a pressure balancing system for two sides of an electrodialysis reversal (EDR) film stack to mitigate or obviate the aforementioned problems.

### SUMMARY OF THE INVENTION

The main objective of the present invention is to provide a pressure balancing system for two sides of an electrodialysis reversal (EDR) film stack. The pressure balancing system includes a first source water inlet, a second source water inlet, an EDR film stack, a first pressure sensor, a second pressure sensor, a third pressure sensor, a fourth pressure sensor, a variable speed pump, a one-way valve, a clean water outlet, a waste water outlet, and a control system module. The EDR film stack has a first inlet port, a second inlet port, a first outlet port, and a second outlet port. The first source water inlet, the first pressure sensor, and the first inlet port of the EDR film stack are connected in sequence. The second source water inlet, the one-way valve, the third pressure sensor, and the second inlet port of the EDR film stack are connected in sequence. The first outlet port of the EDR film stack, the second pressure sensor, and the clean water outlet are connected in sequence. The second outlet port of the EDR film stack, the fourth pressure sensor, and the waste water outlet are connected in sequence. The variable speed pump has two ends connected to the one-way valve and the waste water outlet respectively. The control system module is electrically connected with the first pressure sensor, the second pressure sensor, the third pressure sensor, the fourth pressure sensor, and the variable speed pump.

The four pressure sensors are set to detect pressures of the water flowing through the two inlet ports and the two outlet ports of the EDR film stack. When the clean water outlet is opened to discharge clean water, pressure of the clean water that is to be discharged drops. Accordingly, the second pressure sensor sends a signal to the control system module to allow the control system module to adjust a rotational speed of the variable speed pump (to increase the rotational speed). Moreover, the control system module also opens the rinsing solenoid valve to adjust the pressure of the waste water that is to be discharged (to reduce the pressure). As a result, the pressure of the clean water that is to be discharged and the pressure of the waste water that is to be discharged can be substantially equal.

Thus, with pressure balancing system for the two sides of the EDR film stack, the pressures on the two sides of the EDR film stack can be balanced, and service life of the EDR film stack and water purification efficiency of the EDR film stack can be improved.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a pressure balancing system for two sides of an electrodialysis reversal (EDR) film stack in accordance with the present invention.

### DETAILED DESCRIPTION OF THE PREFERRED EMBODIMENTS

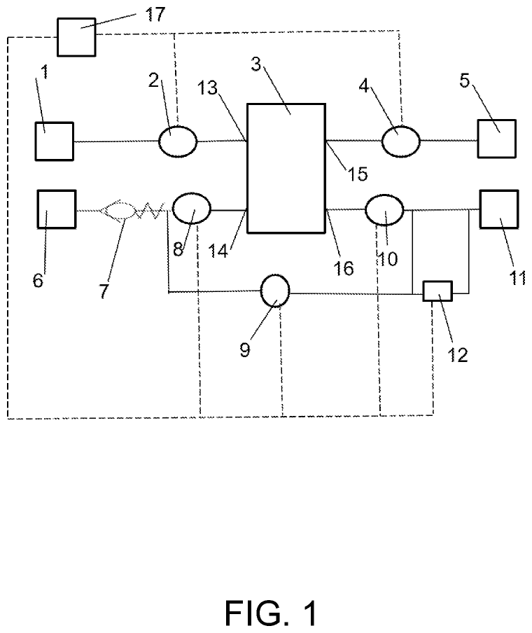

With reference to FIG. 1, a pressure balancing system for two sides of an electrodialysis reversal (EDR) film stack in accordance with the present invention includes a first source water inlet 1, a second source water inlet 6, an EDR film stack 3, a first pressure sensor 2, a second pressure sensor 4, a third pressure sensor 8, a fourth pressure sensor 10, a variable speed pump 9, a one-way valve 7, a clean water outlet 5, a waste water outlet 11, and a control system module 17. The EDR film stack 3 has a first inlet port 13, a second inlet port 14, a first outlet port 15, and a second outlet port 16. The first source water inlet 1, the first pressure sensor 2, and the first inlet port 13 of the EDR film stack 3 are connected in sequence. The second source water inlet 6, the one-way valve 7, the third pressure sensor 8, and the second inlet port 14 of the EDR film stack 3 are connected in sequence. The first outlet port 15 of the EDR film stack 3, the second pressure sensor 4, and the clean water outlet 5 are connected in sequence. The second outlet port 16 of the EDR film stack 3, the fourth pressure sensor 10, and the waste water outlet 11 are connected in sequence. The variable speed pump 9 is a water pump with adjustable pump rotational speed and has two ends connected to the one-way valve 7 and the waste water outlet 11 respectively. The control system module 17 is electrically connected with the first pressure sensor 2, the second pressure sensor 4, the third pressure sensor 8, the fourth pressure sensor 10, and the variable speed pump 9.

The pressure balancing system may further include a rinsing solenoid valve 12. The rinsing solenoid valve 12 has two ends connected with the variable speed pump 9 and the waste water outlet 11 respectively. The control system module 17 is electrically connected with the rinsing solenoid valve 12. With the rinsing solenoid valve 12, pressure of waste water that is to be discharged can be adjusted and pressure on the two sides of the EDR film stack can be balanced.

### EMBODIMENT

As shown in FIG. 1, a pressure balancing system for two sides of an EDR film stack in accordance with the present invention includes a first source water inlet 1, a second source water inlet 6, an EDR film stack 3, a first pressure sensor 2, a second pressure sensor 4, a third pressure sensor 8, a fourth pressure sensor 10, a variable speed pump 9, a one-way valve 7, a clean water outlet 5, a waste water outlet 11, and a rinsing solenoid valve 12. The EDR film stack 3 has a first inlet port 13, a second inlet port 14, a first outlet port 15, and a second outlet port 16. The first source water inlet 1, the first pressure sensor 2, and the first inlet port 13 of the EDR film stack 3 are connected in sequence. The second source water inlet 6, the one-way valve 7, the third pressure sensor 8, and the second inlet port 14 of the EDR film stack 3 are connected in sequence. The first outlet port 15 of the EDR film stack 3, the second pressure sensor 4, and the clean water outlet 5 are connected in sequence. The second outlet port 16 of the EDR film stack 3, the fourth pressure sensor 10, and the waste water outlet 11 are connected in sequence. The variable speed pump 9 is a water pump with adjustable pump rotational speed and has two ends connected to the one-way valve 7 and the waste water outlet 11 respectively. The rinsing solenoid valve 12 has two ends connected with the variable speed pump 9 and the waste water outlet 11 respectively. A control system module 17 is electrically connected with the first pressure sensor 2, the second pressure sensor 4, the third pressure sensor 8, the fourth pressure sensor 10, the variable speed pump 9, and the rinsing solenoid valve 12.

Working principle of the pressure balancing system for the two sides of the EDR film stack is described as follows. The four pressure sensors 2, 4, 8, 10 are set to detect pressures of the water flowing through the two inlet ports 13, 14 and the two outlet ports 15, 16 of the EDR film stack 3. When the clean water outlet 5 is opened to discharge clean water, pressure of the clean water that is to be discharged drops. Accordingly, the second pressure sensor 4 sends a signal to the control system module 17 to allow the control system module 17 to adjust a rotational speed of the variable speed pump 9 (to increase the rotational speed). Moreover, the control system module 17 also opens the rinsing solenoid valve 12 to adjust the pressure of the waste water that is to be discharged (to reduce the pressure). As a result, the pressure of the clean water that is to be discharged and the pressure of the waste water that is to be discharged can be substantially equal. Thus, the pressures on the two sides of the EDR film stack 3 can be balanced, and service life of the EDR film stack 3 and water purification efficiency of the EDR film stack 3 can be improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pressure balancing system for two sides of an electrodialysis reversal (EDR) film stack, the pressure balancing system including a first source water inlet, a second source water inlet, an EDR film stack, a first pressure sensor, a second pressure sensor, a third pressure sensor, a fourth pressure sensor, a variable speed pump, a one-way valve, a clean water outlet, a waste water outlet, and a control system module, wherein
the EDR film stack has a first inlet port, a second inlet port, a first outlet port, and a second outlet port;
the first source water inlet, the first pressure sensor, and the first inlet port of the EDR film stack are connected in sequence;
the second source water inlet, the one-way valve, the third pressure sensor, and the second inlet port of the EDR film stack are connected in sequence;
the first outlet port of the EDR film stack, the second pressure sensor, and the clean water outlet are connected in sequence;
the second outlet port of the EDR film stack, the fourth pressure sensor, and the waste water outlet are connected in sequence;
the variable speed pump has two ends connected to the one-way valve and the waste water outlet respectively; and
the control system module is electrically connected with the first pressure sensor, the second pressure sensor, the third pressure sensor, the fourth pressure sensor, and the variable speed pump.

2. The pressure balancing system for the two sides of the EDR film stack as claimed in claim 1, wherein
the pressure balancing system further includes a rinsing solenoid valve having two ends connected with the variable speed pump and the waste water outlet respectively; and
the control system module is electrically connected with the rinsing solenoid valve.
